(19) United States
(12) Patent Application Publication
(10) Pub. No.: US 2007/0101648 A1
(43) Pub. Date: May 10, 2007

(54) Method and apparatus for endothermic fuel reformation

(76) Inventors: Robert Iverson, Columbus, IN (US); Navin Khadiya, Columbus, IN (US); Samuel N. Crane JR., Columbus, IN (US)

Correspondence Address: BARNES & THORNBURG LLP, 11 SOUTH MERIDIAN, INDIANAPOLIS, IN, 46204, US

(21) Appl. No.: 11/271,765

(22) Filed: Nov. 10, 2005

(51) Int. Cl. C01B 3/02

(52) U.S. Cl. 48/198.7; 423/648.1; 48/127.9

(57) ABSTRACT

A fuel reforming apparatus for reforming a fuel comprises a combustion device and a catalyst. The combustion device is configured to oxidize a portion of the fuel into H₂O. The catalyst is configured to catalyze an endothermic reaction between the H₂O and another portion of the fuel so as to produce a reformate gas. An associated method is disclosed.

### FIELD OF THE DISCLOSURE

The present disclosure relates to methods and apparatus for reforming fuel.

### BACKGROUND OF THE DISCLOSURE

Fuel reformers are used to reform fuel into a reformate gas such as hydrogen (H₂) or carbon monoxide (CO). Such reformate gas may be used for a variety of purposes such as hydrogen-enhancement of engine combustion, emission abatement, and fuel cell operation.

### SUMMARY OF THE DISCLOSURE

According to an aspect of the present disclosure, there is provided a fuel reforming apparatus for reforming a fuel. The apparatus comprises a combustion device and a catalyst. The combustion device is configured to oxidize a portion of the fuel into H₂O (water). The catalyst is configured to catalyze an endothermic reaction between the H₂O and another portion of the fuel so as to produce a reformate gas. An associated method is disclosed.

The above and other features of the present disclosure will become apparent from the following description and the attached drawings.

### BRIEF DESCRIPTION OF THE DRAWINGS

FIG. 1 is a diagrammatic view showing a fuel reforming apparatus for reforming a fuel into a reformate gas for use by one or more components;

FIG. 2A is a diagrammatic view showing a combustion device of the fuel reforming apparatus embodied as a plasma fuel reformer; and

FIG. 2B is a sectional view taken along lines 2B-2B of FIG. 2A.

### DETAILED DESCRIPTION OF THE DRAWINGS

While the concepts of the present disclosure are susceptible to various modifications and alternative forms, specific exemplary embodiments thereof have been shown by way of example in the drawings and will herein be described in detail. It should be understood, however, that there is no intent to limit the disclosure to the particular forms disclosed, but on the contrary, the intention is to cover all modifications, equivalents, and alternatives following within the spirit and scope of the invention as defined by the appended claims.

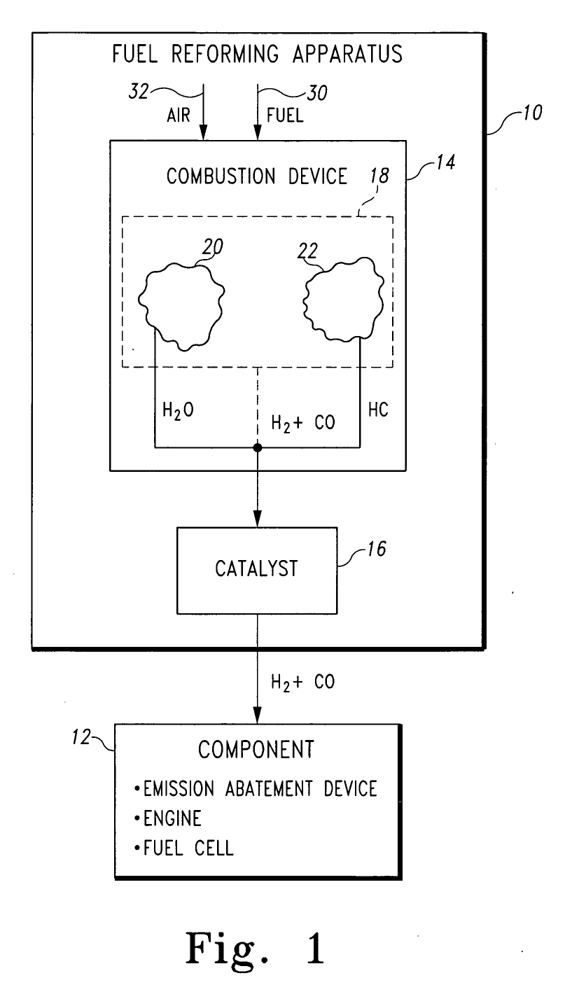

Referring to FIG. 1, there is shown a fuel-reforming apparatus 10 for reforming a fuel such as a hydrocarbon fuel (e.g., diesel, natural gas) into a reformate gas containing hydrogen (H₂) and/or carbon monoxide (CO). The reformate gas may be used with a component 12 that may be embodied in a variety of ways including, but not limited to, an internal combustion engine (e.g., diesel engine, gasoline engine) for hydrogen-enhanced combustion, an emission abatement device (e.g., NOx trap, particulate trap, and/or selective catalytic reduction catalyst) for abatement of emissions present in exhaust gas of the engine, and/or a fuel cell. As such, the apparatus 10 may be mounted onboard a vehicle (or in connection with a stationary power generator) to supply the reformate gas as needed.

The fuel-reforming apparatus 10 comprises a combustion device 14 and catalyst 16 downstream from the combustion device 14. The combustion device 14 oxidizes a portion of the fuel into H₂O. The output of the combustion device 14 further includes another portion of the fuel in the form of, for example, a hydrocarbon (e.g., methane) cracked or uncracked by the combustion device 14. The H₂O and the hydrocarbon (HC) are advanced to the catalyst 16 which catalyzes an endothermic reaction between the H₂O and the HC so as to produce one or more components of the reformate gas such as H₂ and CO. As such, steam-reforming of the HC occurs at the catalyst 16 resulting in reduced temperatures (e.g., about a 200° C. drop in temperature to about 600° C.) at the catalyst 16, thereby promoting the longevity of the useful life of the catalyst 16.

Further, by generating the H₂O with the combustion device 14, the combustion device 14 is able to perform “double duty” in the sense that it (1) not only provides the H₂O for steam-reforming at the catalyst 16 but also acts to (2) partially oxidize a portion of the fuel into H₂ and CO (or at least initiate such partial oxidation). Moreover, the combustion device 14 may be considered to perform “triple duty” in cases where the combustion device 14 is used to crack a portion of the fuel into a simpler HC.

The output of the combustion device 14 may thus comprise a number of components including, for example, H₂O, H₂, CO, CO₂, HC, and N₂. Exemplarily, the composition of the output may be about 9-10% H₂O, about 7-9% H₂, about 13-14% CO, and about 4-5% CO₂, with the remainder including HC's, N₂, and O₂.

The output of the combustion device 14 is advanced to the catalyst 16 which, as alluded to above, catalyzes an endothermic steam-reforming reaction between H₂O and HC components of the output. In addition, to increase the yield of H₂ and/or CO, the catalyst 14 may further be configured to catalyze a partial oxidation reaction between HC and O₂ components of the output to produce more H₂ and CO and/or catalyze a water-shifting reaction between H₂O and CO components of the output to produce even more H₂. As such, exemplarily, the output from the catalyst 16 and thus the final output of the apparatus 10 may comprise about 24% H₂, about 20% CO, and about 4-5% CO₂ (carbon dioxide), with much of the remainder being N₂ (nitrogen). Thus, the catalyst 16 includes not only a steam-reforming portion but may also include a partial oxidation portion and/or a water-shifting portion in order for it also to perform double or triple duty. The following documents relating to catalysts are hereby incorporated by reference herein: (1) U.S. Pat. Nos. 6,261,991; 6,284,217; 5,599,517; 6,946,114; 6,458,334; 4,897,253; 6,627,572; 4,598,062; 6,821,494; and 5,139,992; (2) R. P. O'Connor, E. J. Klein, and L. D. Schmidt, “High Yields of Synthesis Gas By Millisecond Partial Oxidation of Higher Hydrocarbons,” Catalysis Letters, 70, 99-107 (2000); (3) Jameel Shihadeh, Di-Jia Liu, “Low Cost Autothermal Diesel Reforming Catalyst Development,” U.S. Department of Energy Journal of Undergraduate Research, 4, 120-125 (2004); and (4) J. M. Zalc, V. Sokolovskii, and D. G. Löffler, “Are Noble Metal-Based Water-Gas Shift Catalysts for Automotive Fuel Processing?”, Journal of Catalysis, 206, 169-171 (2002). Suppliers of catalysts include Süd-Chemie AG of Munich, Germany; Engelhard Corporation of Iselin, N.J.; and Johnson Matthey Plc of London, England.

To facilitate production of the output of the combustion device 14, an air-and-fuel mixture may be introduced into a combustion region 18 of the device 14 in a stratified manner. In particular, the combustion device may have a fuel input 30 and an air input 32 that cooperate to stratify the air-and-fuel mixture into a number of zones having different air-fuel ratios. For example, the air-and-fuel mixture may be stratified into a first zone 20 and a second zone 22. In such a case, the first zone 20 provides the HC's of the output of the combustion device 14 and the second zone 22 provides the H₂O of the output of the combustion device 14. To do so, the first zone 20 may have a first air-fuel ratio that is substantially fuel-richer than the stoichiometric ratio of the fuel and the second zone 22 may have a second air-fuel ratio that is fuel-leaner than the first air-fuel ratio so as to be at about or fuel-leaner than the stoichiometric ratio.

Energy supplied by the combustion device 14 may be applied primarily to the second zone 22 to facilitate complete oxidation of the fuel into at least H₂O while allowing the fuel of the first zone 20 to pass through the combustion region 18 either cracked or uncracked but otherwise not oxidized. In this way, the H₂O and the HC's can be provided for steam-reforming at the catalyst 16.

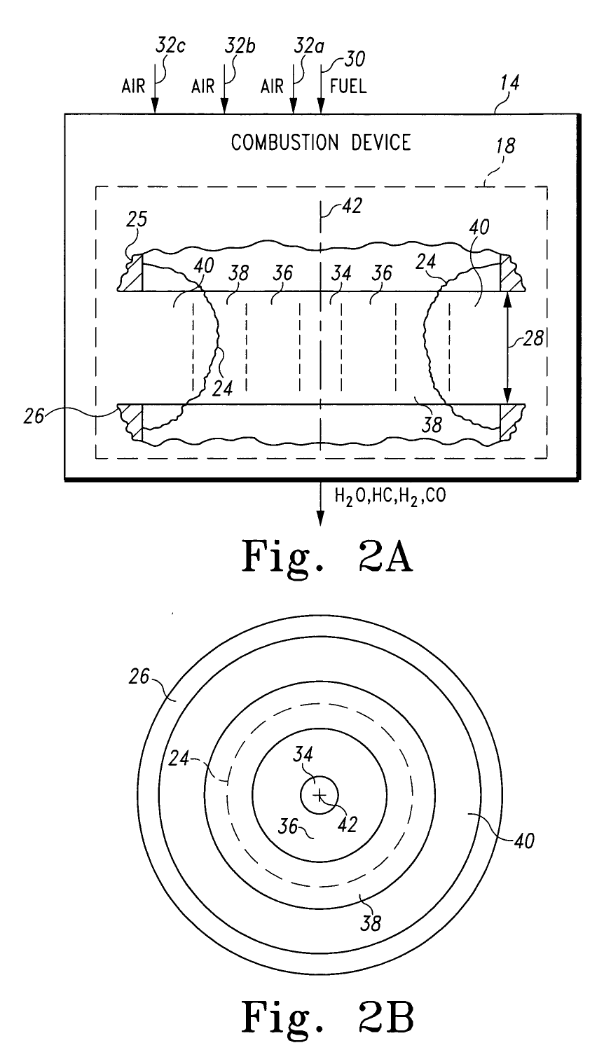

It is to be understood that the device 14 may have any number of fuel inputs and air inputs to achieve a desired stratification of the air-and-fuel mixture to, in turn, provide a desired composition of the output of the device 14. As in the above example, there may be one fuel input and one air input. In other examples, there may be only one fuel input and a plurality of air inputs, only one air input and a plurality of fuel inputs, or a plurality of fuel inputs and a plurality of air inputs. In the exemplary embodiment of FIGS. 2A and 2B discussed below, there are one fuel input and three air inputs.

The combustion device 14 may be embodied as any number of devices capable of oxidizing a portion of the fuel into H₂O. For example, the combustion device 14 may be embodied as any one or more of a catalyst, a fuel-fired burner, and/or a plasma fuel reformer, to name just a few.

Referring to FIGS. 2A and 2B, illustratively, the combustion device 14 is configured, for example, as a plasma fuel reformer. In such a case, the device 14 is configured to generate an electrical arc 24 between an upper electrode 25 and a lower electrode 26 spaced apart from the upper electrode to define an electrode gap 28 therebetween. The arc 24 is generated in the combustion region 18 located in the vicinity of the electrodes 25, 26 and is responsible for initiating conversion of fuel of the air-and-fuel mixture into the components of the output from the device 14.

In the exemplary plasma fuel reformer embodiment of the combustion device 14, the combustion device 14 has one fuel input 30 and three air inputs 32a, 32b, 32c, as shown FIG. 2A, that cooperate to provide the exemplary stratification pattern shown in FIG. 2B. In particular, referring to FIG. 2B, the fuel input 30 and the air inputs 32a, 32b, 32c cooperate to stratify the air-and-fuel mixture into a first zone 34, a second zone 36, a third zone 38, and fourth zone 40.

The first zone 34 is located centrally on an axis 42 of the combustion device 14 and has a first air-fuel ratio substantially fuel-richer than the stoichiometric ratio of the fuel. The fuel input 30 is configured, for example, as a fuel injector mounted on the axis 42 in axial alignment with the first zone 34 so that the first zone 34 is the most fuel-rich of the four zones 34, 36, 38, 40.

The second, third, and fourth zones 36, 38, 40 are arranged in successive, generally concentric rings about the first zone 34. As such, the second zone 36 surrounds the first zone 34, the third zone 38 surrounds the second zone 36, and the fourth zone 40 surrounds the third zone 38.

The second zone 36 has a second air-fuel ratio that is fuel-leaner than the first air-fuel ratio. Exemplarily, the oxygen-to-carbon ratio of the second zone 36 is about 1.0. The first air input 32a is primarily responsible for supplying the air of the second zone 36.

The third zone 38 has a third air-fuel ratio fuel-leaner than the second air-fuel ratio so as to be at about the stoichiometric ratio. The second air input 32b is primarily responsible for supplying the air of the third zone 38.

The fourth zone 40 has a fourth air-fuel ratio fuel-leaner than the third air-fuel ratio and the stoichiometric ratio. The third air input 32c is primarily responsible for supplying the air of the fourth zone 40.

The generally stoichiometric third air-fuel ratio is conducive to generation of the arc 24 therein. As such, the arc 24 is present primarily in the third zone 38.

The four zones 34, 36, 38, 40 are advanced through the combustion region 18 so as to provide the components of the output of the device 14. In particular, the first zone 34 provides the cracked or uncracked HC's of the output for steam-reformation and possibly partial oxidation at the catalyst 16. The second zone 36 provides the H₂ and CO of the output, the CO being useful for, among other reasons, possible water-shifting at the catalyst 16. Each of the third and fourth zones 38, 40 provides the H₂O of the output for steam reformation and possible water-shifting at the catalyst 16. More particularly, as alluded to above, the stoichiometric third air-fuel ratio facilitates generation of the arc 24 therein while also facilitating oxidation of fuel into H₂O. The less-than-stoichiometric fourth air-fuel ratio further facilitates oxidation of fuel into H₂O to increase the H₂O yield of the output. As such, stratification of the air-and-fuel mixture promotes generation of H₂O, HC's, and CO for use at the catalyst 16 to increase the yield of the reformate gas (H₂ and/or CO).

The air inputs 32a, 32b, 32c may be arranged in a variety of ways to produce the thus-described stratification in conjunction with the fuel input 30. For example, each of the air input 32a, 32b, 32c may be secured to and/or formed in the device 14 to provide the device 14 with three concentric annular passageways to direct air to the respective zones.

Exemplarily, the combustion device 14 may be configured in a manner similar to any of the plasma fuel reformers disclosed in U.S. patent application Ser. Nos. 10/452,623 and 10/843,776 and U.S. Provisional Patent Application No. 60/660,362, the disclosure of each of which is hereby incorporated by reference herein. It is be further understood that the device 14, when configured as a plasma fuel reformer, may include a housing containing not only components of the plasma-generating head but also the catalyst 16. In other words, the housing of the plasma-generating head may be secured directly to a reactor tube containing the catalyst 16 and extending for a length to increase the residence time of the reactants in the reactor tube to promote production of the reformate gas.

While the concepts of the present disclosure have been illustrated and described in detail in the drawings and foregoing description, such illustration and description is to be considered as exemplary and not restrictive in character, it being understood that only illustrative embodiments have been shown and described and that all changes and modifications that come within the spirit of the disclosure are desired to be protected.

There are a plurality of advantages of the concepts of the present disclosure arising from the various features of the systems described herein. It will be noted that alternative embodiments of each of the systems of the present disclosure may not include all of the features described yet still benefit from at least some of the advantages of such features. Those of ordinary skill in the art may readily devise their own implementations of a system that incorporate one or more of the features of the present disclosure and fall within the spirit and scope of the invention as defined by the appended claims.

1. A method of reforming a fuel, comprising the steps of:
oxidizing a portion of the fuel into H₂O, and
endothermically catalytically reacting the H₂O with another portion of the fuel so as to produce a reformate gas.

2. The method of claim 1, wherein the reacting step comprises producing H₂ or CO.

3. The method of claim 1, further comprising the step of catalytically partially oxidizing a portion of the fuel so as to produce H₂ or CO.

4. The method of claim 1, further comprising the steps of:
partially oxidizing a portion of the fuel into CO, and
catalytically reacting the CO with the H₂O so as to produce H₂.

5. The method of claim 1, further comprising the step of stratifying an air-and-fuel mixture in a combustion region such that the air-and-fuel mixture comprises zones having different air-fuel ratios.

6. The method of claim 5, wherein the stratifying step comprises stratifying the air-and-fuel mixture into a first zone having a first air-fuel ratio fuel-richer than the stoichiometric ratio of the fuel and a second zone having a second air-fuel ratio that is fuel-leaner than the first air-fuel ratio so as to be at about or fuel-leaner than the stoichiometric ratio, further comprising (i) advancing the first and second zones through the combustion region so as to produce an output comprising a hydrocarbon provided by the first zone and H₂O provided by the second zone as a result of the oxidizing step, and (ii) advancing the hydrocarbon and the H₂O to a catalyst.

7. The method of claim 6, wherein:
the stratifying step comprises stratifying the air-and-fuel mixture into a third zone having a third air-fuel ratio fuel-leaner than the first air-fuel ratio and fuel-richer than the second air-fuel ratio, and
the advancing step comprises advancing the third zone through the combustion region so as to partially oxidize a hydrocarbon of the third zone.

8. The method of claim 5, wherein the stratifying step comprises stratifying the air-and-fuel mixture into a first zone having a first air-fuel ratio fuel-richer than the stoichiometric ratio of the fuel, a second zone surrounding the first zone and having a second air-fuel ratio fuel-leaner than the first air-fuel ratio, a third zone surrounding the second zone and having a third air-fuel ratio fuel-leaner than the second air-fuel ratio so as to be at about the stoichiometric ratio, and a fourth zone surrounding the third zone and having a fourth air-fuel ratio fuel-leaner than the third air-fuel ratio, further comprising (i) advancing the first, second, third, and fourth zones through the combustion region, (ii) generating an electrical arc in the third zone so as to produce an output comprising a hydrocarbon provided by the first zone, CO provided by the second zone, and H₂O provided by the third and fourth zones as part of the oxidizing step, and (iii) advancing the hydrocarbon, the CO, and the H₂O to a catalyst.

9. The method of claim 6, wherein the oxidizing step comprises generating an electrical arc in the second zone.

10. A fuel reforming apparatus, comprising:
a combustion device configured to oxidize a portion of a fuel into H₂O, and
a catalyst configured to catalyze an endothermic reaction between the H₂O and another portion of the fuel so as to produce a reformate gas.

11. The fuel reforming apparatus of claim 10, wherein the combustion device is configured as a plasma fuel reformer.

12. The fuel reforming apparatus of claim 10, wherein the reformats gas comprises H₂ or CO.

13. The fuel reforming apparatus of claim 10, wherein:
the combustion device is configured to output a hydrocarbon, and
the catalyst is configured to partially oxidize the hydrocarbon.

14. The fuel reforming apparatus of claim 10, wherein:
the combustion device is configured to partially oxidize a portion of the fuel into CO, and
the catalyst is configured to react the CO with the H₂O so as to produce H₂.

15. The fuel reforming apparatus of claim 14, wherein:
the combustion device is configured to output a hydrocarbon, and
the catalyst is configured to partially oxidize the hydrocarbon into H₂ or CO.

16. The fuel reforming apparatus of claim 10, wherein:
the combustion device comprises a fuel input and at least one air input to generate a stratified air-and-fuel mixture comprising a first zone having a first air-fuel ratio fuel-richer than the stoichiometric ratio of the fuel and a second zone having a second air-fuel ratio that is fuel-leaner than the first air-fuel ratio so as to be at about or fuel-leaner than the stoichiometric ratio, and
the combustion device is configured to produce an output comprising a hydrocarbon provided by the first zone and H₂O provided by the second zone.

17. The fuel reforming apparatus of claim 16, wherein the at least one air input comprises first and second air inputs that cooperate with the fuel input to provide the stratified air-and-fuel mixture with a third zone located between the first zone and the second zone and having a third air-fuel ratio fuel-leaner than the first air-fuel ratio and fuel-richer than the second air-fuel ratio, and
the combustion device is configured to partially oxidize the fuel of the third zone.

18. The fuel reforming apparatus of claim 17, wherein the oxygen-to-carbon ratio of the third zone is about 1.0.

19. The fuel reforming apparatus of claim 10, wherein:
the combustion device comprises a fuel input and first, second, and third air inputs to generate a stratified air-and-fuel mixture comprising a first zone having a first air-fuel ratio fuel-richer than the stoichiometric ratio of the fuel, a second zone having a second air-fuel ratio fuel-leaner than the first air-fuel ratio, a third zone having a third air-fuel ratio fuel-leaner than the second air-fuel ratio so as to be at about the stoichiometric ratio, and a fourth zone having a fourth air-fuel ratio fuel-leaner than the third air-fuel ratio, and
the combustion device is configured to generate an electrical arc in the third zone such that an output of the combustion device comprises a hydrocarbon provided by the first zone, H₂ or CO provided by the second zone, and H₂O provided by the third and fourth zones.

20. The fuel reforming apparatus of claim 10, wherein the catalyst is configured as a steam-reforming catalyst and a partial oxidation catalyst.
